(19) United States
(12) Patent Application Publication
(10) Pub. No.: US 2019/0382554 A1
(43) Pub. Date: Dec. 19, 2019

(54) Plasticized Cellulose Ester Derivatives, A Process For Its Production And Its Uses

(71) Applicant: Rhodia Acetow GmbH, Paris (FR)

(72) Inventors: Caroll Vergelati, Saint Baudille de la Tour (FR); Anothony Bocahut, Lyon (FR); Pierre Yves Lahary, Lyon (FR); Alexandre Corbin, Saint Symphorien (FR); Gregory Landelle, Lyon (FR); Olivier Andrea, Mion (FR)

(73) Assignee: Rhodia Acetow GmbH, Paris (FR)

(21) Appl. No.: 15/747,059

(22) PCT Filed: Jul. 22, 2016
(86) PCT No.: PCT/EP2016/067592

§ 371 Date: Sep. 25, 2018

(30) Foreign Application Priority Data
Jul. 24, 2015 (EP) 15306203.9
Jul. 24, 2015 (EP) 15306204.7

(51) Int. Cl. C08K 5/103

(52) U.S. Cl. CPC C08K 5/103; C08L 1/14

(57) ABSTRACT

The present invention relates to plasticized cellulose ester derivative compositions comprising a cellulose ester derivative and at least a one compound having a molecular weight preferably equal to or more than 200 g/mol and equal to or less than 600 g/mol wherein the exudation, determined by Isothermal ThermoGravimetric Analysis at 60° C. during 20 hours, is equal to or less than 1.00%.

The compositions display efficient plasticizing performances and limited exudation in time and temperature.

The present invention further relates to the use of a compound of formula (I), formula (II), formula (III) or an acyl trialkyl citrate as a plasticizer of a cellulose ester derivative and a process for the manufacture of a plasticized article.

This application claims priority to European application No. 15306203.9 filed on 24 of Jul. 2015 and of European application No. 15306204.7 filed on 24 of Jul. 2015, the whole content of this application being incorporated herein by reference for all purposes.

The present invention concerns plasticized compositions comprising a cellulose ester derivative and more particularly cellulose acetate, a process for its production and its uses.

### BACKGROUND OF THE INVENTION

Cellulose acetate itself has no thermoplasticity. The use of an appropriate plasticizer in the thermal molding softens the polymer and gives rise to a glass transition temperature suitable for processing. Further, the addition of a plasticizer can improve the flexibility of a molded article for example diethylphthalate (DEP) or triacetin.

However the glass transition temperature of these compositions is often too low and limits the reachable applications. Therefore it would be advantageous to develop new solutions increasing the maximal use temperature for a material comprising a cellulose ester derivative while maintaining the other mechanical properties. In addition constant trouble has been experienced owing to the tendency of plasticizers to separate or exude on the surface, out from the polymer matrix to the air or into another material placed in close contact. This phenomenon is commonly known as plasticizer migration, also named plasticizer exudation or plasticizer demixing.

Moreover, most of the plasticizers in the art have a fossil origin. Some of them have to answer to toxico-eco toxicological regulation issues (family of phthalates for example), and very few are potentially bio-based such as triacetin and triethyl citrate.

The present invention aims notably at extending the panel of potentially bio-based plasticizers of cellulose derivatives.

WO2012/004727 discloses compositions comprising 70% and 72% of cellulose acetate with a 39.8% degree of acetylation and respectively 30% and 28% of acetyl triethyl citrate. These compositions were passed through a single-screw extruder and display insufficient plasticization.

The present invention also aims at providing new plasticizers that can provide an efficient plasticizing performance, in particular comparable or even better plasticizing performances than reference plasticizers and permitting acceptable or even substantially improved exudation behaviour of the plasticized composition in time and temperature, in particular when compared to reference compositions.

### BRIEF DESCRIPTION OF THE INVENTION

The present invention has for purpose to solve these problems.

Therefore the present invention concerns a plasticized cellulose ester derivative composition comprising a cellulose ester derivative and at least one plasticizer having a molecular weight equal to or more than 100 g/mol and equal to or less than 600 g/mol wherein the exudation of the plasticized composition, determined by Isothermal ThermoGravimetric Analysis after heating at 60° C. during 20 hours, is equal to or less than 2.50%.

In a preferred embodiment, the present invention concerns a plasticized cellulose ester derivative composition comprising a cellulose ester derivative and at least one plasticizer of formula (I)

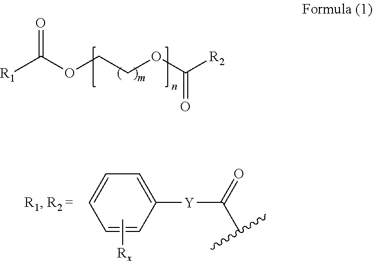

wherein

n is an integer equal to or more than 1 and equal to or less than 5,

m is an integer equal to 1 or 2,

Y represents a bond or a —C═C— in configuration trans or configuration (E),

x is an integer equal to or more than 0 and equal to or less than 5 and

R represents an hydroxyl, a (C₁-C₄) alkyl group or a —O(C₁-C₄) alkyl group.

In another aspect of the application, the present invention concerns a plasticized cellulose ester derivative composition comprising a cellulose ester derivative and at least one compound of formula (III):

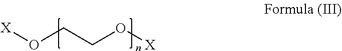

wherein

n represents an integer varying from 1 to 10, and

X represents a group of formula (IV)

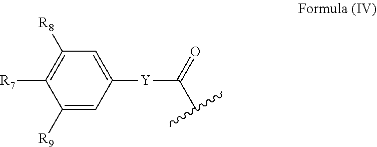

with

R₇ represents a hydrogen atom or a hydroxyl group,

R₈ and R₉ independently represent a hydrogen atom, an hydroxyl group, a (C₁-C₄)alkyl group or a —O(C₁-C₄)alkyl group,

Y represents a bond or a group —C═C— in configuration trans or E configuration

and when Y is a bond, at least one of R₇, R₈ and R₉ is different from a hydrogen atom.

In another aspect of the application, the present invention concerns a plasticized cellulose ester derivative composition comprising a cellulose ester derivative and at least a compound of formula (II)

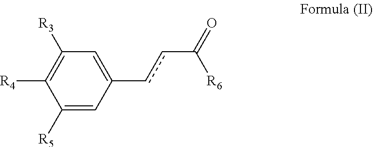

wherein

R₄ represents a hydrogen atom or a hydroxyl group,

R₃ and R₅ independently represent a hydrogen atom, a (C1-C4)alkyl group or a —O(C1-C4)alkyl group,

R₆ represents a hydrogen atom, an hydroxyl group, a (C1-C4)alkyl group, a benzyl group, a O(C1 C4)alkyl group or a —Obenzyl group, and

[symbol] represents a single bond or a double bond.

In a further aspect of the application, the present invention concerns a plasticized cellulose ester derivative composition comprising a cellulose ester derivative and an acyl trialkyl citrate.

In another particular embodiment, the present invention concerns the use of a compound of formula (I) as defined above as plasticizer of a cellulose ester derivative, and more particularly of cellulose ester, and even more particularly of cellulose acetate.

In another particular embodiment, the present invention concerns the use of a compound of formula (II) as defined above as plasticizer of a cellulose ester derivative, and more particularly of cellulose ester, and even more particularly of cellulose acetate.

In another particular embodiment, the present invention concerns the use of a compound of formula (III) as defined above as plasticizer of a cellulose ester derivative, and more particularly of cellulose ester, and even more particularly of cellulose acetate.

In another particular embodiment, the present invention concerns a process for the manufacture of a plasticized article comprising the steps of:

(a) having a composition according to the present invention, and

(b) forming the composition to produce the article, for example by means of extrusion and injection molding.

In a further particular embodiment, the present invention relates to the use of a composition according to the present invention for producing a plasticized article, for example a plasticized article selected from a cosmetic packaging, food packaging, hair accessories, wiring devices, electronic devices, home appliances, eye glass frame and tool handle.

In the context of the present invention, the term “comprising” is intended to include the meaning of “consisting of”. In the present invention, designations in singular are intended to include the plural; “a plasticizer” is intended to denote also “more than one plasticizer”, “plasticizers” or “a plurality of plasticizers”.

Throughout the description, including the claims, the term “comprising a” should be understood as being synonymous with “comprising at least one”, unless otherwise stated. The terms “between . . . and . . . ” and “from . . . to . . . ” should be understood as being inclusive of the limits, unless otherwise specified.

In the context of the present invention, the expression:
“a (C₁-C₄)alkyl group” as used herein refers to a linear or branched, saturated or unsaturated alkyl group having from 1 to 4 carbon atoms. Examples are, but are not limited to a methyl group, an ethyl group, a propyl group, a secondary butyl group, a n-butyl group, a tertio-butyl group,
a “reference composition” means a composition comprising the same amount by weight of plasticizer in the composition as the tested one, and for example a composition comprising the same amount by weight of triacetin as the amount of the tested plasticizer.
“exudation” means that a product is released from a matrix of origin. More particularly in the framework of the present invention, exudation may be stated when the plasticizer releases from the cellulose ester derivative matrix over a period of time. The measure of the amount of plasticizer that can exudate from the cellulose ester derivative matrix may be performed by Isothermal ThermoGravimetric Analysis (I-TGA) after heating at 60° C. during 20 hours, as it will be more particularly illustrated in the examples. The exudation amount is expressed in percentage and is calculated as follows:

$$Exudation = \frac{Weight loss}{Weight of the sample} \times 100$$

“cellulose ester derivative” refers to any cellulose ester or to any of its derivative. A cellulose ester derives from cellulose by reaction with an organic acid. The structure of cellulose is characterized by a repetitive building block of anhydroglucose C₆H₁₀O₅ which are specifically linked by a (1→4)β(diequatorial) linkage.
“degree of substitution” refers to the average number of substituent groups attached per base unit. Cellulose for example has three reactive groups. The extent of the substitution can also be expressed as the percent of a substituent group, eg % acetyl.
“polyalkylene glycol ester” means a compound defined by Formula (I)

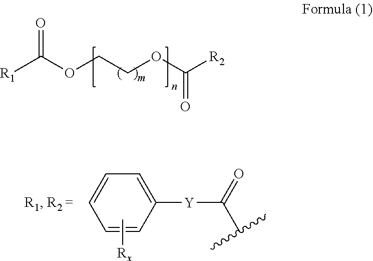

Wherein

n is an integer equal to or more than 1 and equal to or less than 5,

m is an integer equal to 1 or 2,

Y represents a bond or a —C═C— in configuration trans or configuration (E),

x is an integer equal to or more than 0 and equal to or less than 5 and

R represents an hydroxyl, a (C₁-C₄) alkyl group or a —O(C₁-C₄) alkyl group.

In the framework of the present invention, the plasticizing performance may be evaluated by the depletion of the glass transition temperature of the polymer, induced by the introduction of the plasticizer.

In the sense of the invention, a material of renewable origin, also known as a biomaterial or biobased molecule, or alternatively a biosourced material, is a material derived from starting materials of renewable origin, and for example from plants. A material may comprise a content of biocarbon and a content of fossil carbon. In the sense of the present invention, a material may be qualified as a biomaterial or a biobased molecule when it is extracted from vegetal biomass, which may be selected in a group comprising a plant or a part thereof (e.g. leave, stem, root).

### DETAILED DESCRIPTION

### Cellulose Derivative

The cellulose derivative is generally an organic and particularly aliphatic ester of cellulose.

The cellulose derivative may also encompass ethylcellulose, hydroxyethylcellulose, methylcellulose, hydroxymethylcellulose, hydroxypropylcellulose and carboxymethylcellulose.

Advantageously, the cellulose ester has an acyl group having 2 to 4 carbon atoms as the ester group. It may be mixed esters of cellulose. There may be mentioned as an example of suitable cellulose ester in the context of the invention: cellulose acetate, cellulose propionate, cellulose butyrate, cellulose acetate propionate, cellulose acetate butyrate, cellulose acetate propionate butyrate, carboxymethyl cellulose acetate propionate and mixtures thereof. The butyryl group forming butyrate may be linear or branched.

According to a particular embodiment, cellulose ester may be selected among cellulose acetate, cellulose propionate and cellulose butyrate and even more particularly, the cellulose ester is cellulose acetate.

According to a particular embodiment of the invention, the cellulose derivative is obtained from cellulose from high quality wood pulp, or from cellulose from cotton linters. By “high quality wood pulp” is meant a wood pulp comprising at least 95% by weight of alpha cellulose. The amount of alpha cellulose is determined according to ISO standard 692.

When the cellulose ester is cellulose acetate, the molecular weight may range from 30000 to 150000 in particular from 50000 to 120000 and more particularly from 70000 to 100000.

Advantageously, the degree of substitution (DS) of the cellulose, which is also expressed as acetyl value (combined acetic acid (%)), if from 2 to 3, preferably from 2.0 to 2.6, and most preferably from 2.3 to 2.5, for example is 2.45. The degree of substitution of the cellulose is determined in accordance with ASTM D871-72.

### Plasticizer

The plasticized composition according to the invention comprises at least one plasticizer having a molecular weight equal to or more than 100 g/mol and equal to or less than 600 g/mol.

The selected plasticizers display a high compatibility with cellulose ester derivative. The average molecular weight of such plasticizers generally is equal to or more than 100 g/mol, is equal to or more than 200 g/mol, preferably equal to or more than 250 g/mol, or even more preferably equal to or more than 300 g/mol. The average molecular weight of such plasticizers generally is equal or less than 600 g/mol, preferably equal or less than 450 g/mol.

According to a preferred aspect of the invention, the at least one plasticizer is a polyalkylene glycol ester of formula (I)

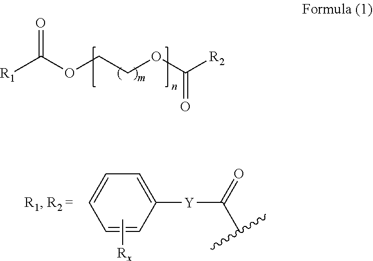

wherein

n is an integer equal to or more than 1 and equal to or less than 5,

m is an integer equal to 1 or 2,

Y represents a bond or a —C═C— in configuration trans or configuration (E),

x is an integer equal to or more than 0 and equal to or less than 5 and

R represents an hydroxyl, a (C₁-C₄) alkyl group or a —O(C₁-C₄) alkyl group.

According to a preferred embodiment, the at least one plasticizer is selected from triethylene glycol dibenzoate (also named dibenzoyl triethylene glycol), diethylene glycol dibenzoate, tripropylene glycol dibenzoate and dipropylene glycol dibenzoate, preferably triethylene glycol dibenzoate.

According to a preferred aspect of the present invention, the at least one plasticizer is a compound of formula (III). The compound of formula (III) is defined as follows

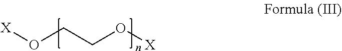

wherein

n represents an integer varying from 1 to 10, and

X represents a group of formula (IV)

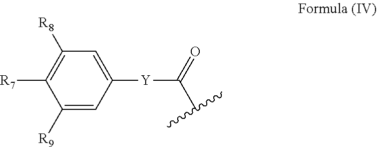

with

R₇ represents a hydrogen atom or a hydroxyl group,

R₈ and R₉ independently represent a hydrogen atom, an hydroxyl group, a (C₁-C₄)alkyl group or a —O(C₁-C₄)alkyl group,

Y represents a bond or a group —C═C— in configuration trans or E configuration

and when Y is a bond, at least one of R₇, R₈ and R₉ is different from a hydrogen atom.

n may be 2, 3, 4, 5, 6, 7, 8, 9 or 10. It may in particular be 2, 3 and 4.

According to a particular embodiment, the molecular weight is at least 200 g/mol, or at least 250 g/mol, or even at least 300 g/mol.

The molecular weight of the compound of formula (III) may range from 200 to 600, more particularly from 250 to 500, and even more particularly from 350 to 450.

According to a particular embodiment, a compound of formula (III) is defined as having a R₇ group being a hydroxyl group or a hydrogen atom, having R₈ and R₉ independently representing a hydrogen atom, a methyl group or a methoxy group, having n being an integer from 2 to 6, preferentially from 2 to 4 and having Y as defined above.

According to a further embodiment, the present invention concerns a compound of formula (III) wherein X represents the group (IVa)

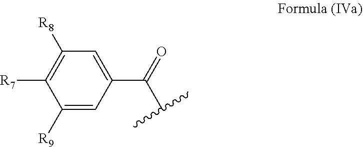

with R₇, R₈, R₉ and n having the same meanings as above. Said compounds may also be named compounds of formula (IIIa).

Said compounds of formula (IIIa) are more particularly dedicated to provide an efficient plasticizing performance, in particular comparable or even better plasticizing performances than reference plasticizers.

Said compounds of formula (IIIa) are furthermore dedicated to provide comparable exudation, or even a limited exudation in time and temperature, in particular when compared to reference compositions.

Said compounds of formula (IIIa) are more particularly suitable for obtaining plasticized compositions comprising cellulose ester derivatives in spite of their molecular weight greater than 200 g/mol, 250 g/mol, or even 350 g/mol.

According to a more particular embodiment, the compound of formula (III) with X representing a group (IVa) is further defined as having a R₇ group being a hydroxyl group and having R₈ and R₉ independently representing a hydrogen atom, a methyl group or a methoxy group, having n being an integer from 2 to 6, preferentially from 2 to 4.

The following structure illustrates a compound of formula (III) wherein X represents the group (IVa), according to the present invention:

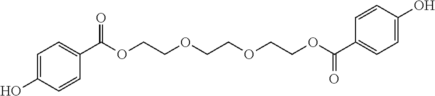 [SMILES: O=C(OCCOCCOCCOC(=O)c1ccc(O)cc1)c1ccc(O)cc1]

(1), dihydroxybenzoyl triethylene glycol. Its molecular weight is 390 g/mol.

According to a further embodiment, the present invention concerns a compound of formula (III) wherein X represents the group (IVb)

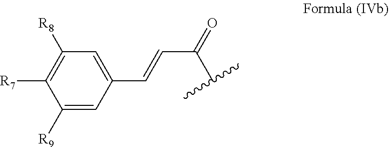

with R₇, R₈, R₉ and n having the same meanings as above. Said compounds may also be named compounds of formula (IIIb).

Said compounds of formula (IIIb) are more particularly dedicated to provide new families aiming at extending the panel of potentially biosourced plasticizers of cellulose derivatives.

Said compounds of formula (IIIb) more particularly suitable for obtaining plasticized compositions comprising cellulose ester derivatives in spite of their molecular weight greater than 200 g/mol, 250 g/mol, or even 350 g/mol.

According to a more particular embodiment, the compound of formula (III) with X representing a group (IVb) is further defined as having a R₇ group being a hydrogen atom and having R₈ and R₉ independently representing a hydrogen atom, a methyl group or a methoxy group, having n being an integer from 2 to 6, preferentially from 2 to 4.

The following structure illustrates a compound of formula (III) wherein X represents the group (IVb), according to the present invention:

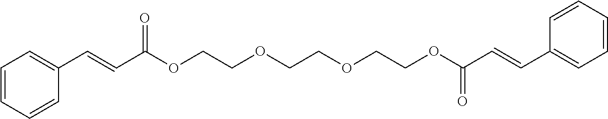 [SMILES: O=C(/C=C/c1ccccc1)OCCOCCOCCOC(=O)/C=C/c1ccccc1]

(2), dicinnamoyl triethylene glcyol. Its molecular weight is 410 g/mol.

According to a particular embodiment, the compound of formula (III) is a biobased molecule.

According to another particular embodiment, the compound of formula (III) comes from a synthetic process where the starting matter occurs naturally in plants, trees, fruits or vegetables.

As a way of illustration, compounds of formula (III) wherein X represents the group (IVb), and more specifically compound (2) as defined above, are more particularly interesting with respect to the technical problem consisting in implementing biobased molecule as plasticizers. Said cinnamoyl derivatives may be a source for the synthesis of further compounds of formula (III) according to methods well known from the man skilled in the art.

Coumaric acid, ferulic acid, sinapic acid and their corresponding derivatives, and more particularly their corresponding aldehydes may also be considered as potential sources for the synthesis of compounds of formula (III).

Cinnamic acid may for example be extracted from cinnamon; coumaric acid may for example be extracted from peanut, garlic, tomatoes, wine and vinegar; sinapic acid may for example be extracted from wine and vinegar and ferulic acid may for example be extracted from seeds of coffee, apple, peanut and orange.

In another aspect of the present invention, the at least one plasticizer is a compound of formula (II). The compound of formula (II) is defined as follows

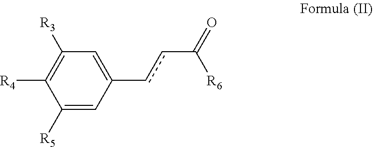

wherein

R₄ represents a hydrogen atom or a hydroxyl group,

R₃ and R₅ independently represent a hydrogen atom, a (C₁-C₄)alkyl group or a —O(C₁-C₄)alkyl group,

R₆ represents a hydrogen atom, an hydroxyl group, a (C₁-C₄)alkyl group, a benzyl group, a O(C₁-C₄)alkyl group or a —Obenzyl group, and

[symbol] represents a single bond or a double bond.

According to a particular embodiment, a compound of formula (II) is defined as having a R₄ group which is as defined above; having R₃ and R₅ independently representing a hydrogen atom or a O(C₁-C₄)alkyl group, preferentially a methoxy or ethoxy group, and having being as defined above.

According to a further particular embodiment, a compound of formula (II) is defined as having R₃, R₄, R₅ and R₆ as defined above and having representing a single bond.

According to another particular embodiment, a compound of formula (II) is defined as having R₃, R₄, R₅ and R₆ as defined above and represents a double bond, and more particularly in a trans configuration or configuration (E).

According to a particular embodiment, the compound of formula (II) is a biobased molecule.

According to another particular embodiment, the compound of formula (II) comes from a synthetic process where the starting matter occurs naturally in plants, trees, fruits or vegetables.

As a way of illustration of a compound of formula (II) that is a biobased molecule, cinnamic acid, corresponding to a compound of formula (II) wherein R₃═R₄=R₅═H, represents a double bond and R₆═OH may be mentioned. Said cinnamic acid occurs naturally in a number of plants. It may be obtained from oil of cinnamon, or from balsams such as storax.

Therefore, said cinnamic acid may be a source for the synthesis of further compounds of formula (II) according to methods well known from the man skilled in the art.

Coumaric acid, ferulic acid, sinapic acid and their corresponding derivatives, and more particularly their corresponding aldehydes may also be considered as potential sources for the synthesis of compounds of formula (II).

Cinnamic acid may for example be extracted from cinnamon; coumaric acid may for example be extracted from peanut, garlic, tomatoes, wine and vinegar; sinapic acid may for example be extracted from wine and vinegar and ferulic acid may for example be extracted from seeds of coffee, apple, peanut and orange.

The two following structures illustrate particular compounds of formula (II) according to the present invention:

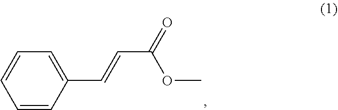

methyl-trans-cinnamate, also named “MTC” and

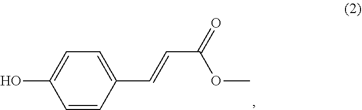

methyl-4-hydroxycinnamate, also named “M4HC”.

MTC presents a molecular weight of 162 g/mol and M4HC presents a molecular weight of 179 g/mol.

In another aspect of the invention, the at least one plasticizer is an acyl trialkyl citrate, preferably is acetyl triethyl citrate.

In another aspect of the invention, the at least one plasticizer is suitable for food contact.

### Composition

The present invention relates to a plasticized cellulose ester derivative composition comprising

(a) at least one cellulose ester derivative, which is present in an amount ranging from 60 and 95% by weight, in particular from 65 to 85% by weight, more particularly from 70 to 80% by weight, with respect to the total weight of the composition,

(b) at least one plasticizer according to the invention, which is present in an amount ranging from 5 and 40% by weight, in particular from 15 to 35% by weight, more particularly from 20 to 30% by weight, with respect to the total weight of the composition, and

(c) optionally at least one additional compound, which is present in an amount ranging from 0 to 15% by weight, in particular from 0.1 to 10% by weight, with respect to the total weight of the composition.

In a preferred aspect of the invention, the present invention relates to a plasticized cellulose ester derivative composition comprising

(a) at least one cellulose ester derivative, which is present in an amount ranging from 60 and 95% by weight, in particular from 65 to 85% by weight, more particularly from 70 to 80% by weight, with respect to the total weight of the composition,

(b) at least one compound of formula (I), which is present in an amount ranging from 5 and 40% by weight, in particular from 15 to 35% by weight, more particularly from 20 to 30% by weight, with respect to the total weight of the composition, and

(c) optionally at least one additional compound, which is present in an amount ranging from 0 to 15% by weight, in particular from 0.1 to 10% by weight, with respect to the total weight of the composition.

The composition according to the invention may further encompass at least one additional compound.

Among said additional compounds, anti-UV compounds, stabilizers, acid scavengers, lubricants, pigments, dyes, odor maskers, brighteners and mixtures thereof may be cited, as any other optional additives usually used to prepare cellulose derivatives and more particularly cellulose acetate, for example depending on the application.

The composition may also comprise an additional plasticizer or co-plasticizer being different from the plasticizer according to the present invention.

Among said additional plasticizer or co-plasticizer the following may be cited: triacetin, diethyl phthalate, dimethyl phthalate, butyl phthalyl butyl glycolate, diethyl citrate, dimethoxy ethyl phthalate, ethyl phthalyl ethyl glycolate, methyl phthalyl ethyl glycolate, sulfonamides n-ethyl-o, p-toluene, triphenyl phosphate, tricresyl phosphate, dibutoxy ethyl phthalate, diamyl phthalate, tributyl citrate, acetyl tributyl citrate, acetyl tripropyl citrate, tripropionin, tributyrin, o,p-toluene sulfonamide, pentaerythritol tetraacetate, dibutyl tartrate, diethylene glycol diacetate, diethylene glycol dipropionate, dibutyl adipate, dioctyl adipate, dibutyl azelate, trichloroethyl phosphate, tributyl phosphate, di-n-butyl sebacate, dibutyl phthalate, dioctyl phthalate, butylbenzyl phthalate, 2-ethylhexyl adipate, di-2-ethylhexyl phthalate and mixtures thereof.

When present, the additional compounds may be present in the composition in a content ranging from 0.05 to 15% by weight and preferably ranging from 0.1 to 10% by weight relative to the total weight of the composition.

It is a matter of routine operations for a person skilled in the art to adjust the nature and amount of the additional compounds present in the compositions in accordance with the invention such that the desired properties thereof are not thereby affected.

This is all the more true in connection to the optional presence of an additional plasticizer that should not alter the desired properties in connection to the presence of a plasticizer of formula (I), in particular with respect to the plasticizing power and the limited exudation.

In a preferred aspect of the invention, the present invention relates to a plasticized cellulose ester derivative composition comprising

(a) at least one cellulose ester derivative, which is present in an amount ranging from 60 and 95% by weight, in particular from 65 to 85% by weight, more particularly from 70 to 80% by weight, with respect to the total weight of the composition,

(b) at least one compound of formula (II), which is present in an amount ranging from 5 and 40% by weight, in particular from 15 to 35% by weight, more particularly from 20 to 30% by weight, with respect to the total weight of the composition, and

(c) optionally at least one additional compound, which is present in an amount ranging from 0 to 15% by weight, in particular from 0.1 to 10% by weight, with respect to the total weight of the composition.

The composition according to the invention may further encompass at least one additional compound.

Among said additional compounds, anti-UV compounds, stabilizers, acid scavengers, lubricants, pigments, dyes, odor maskers, brighteners and mixtures thereof may be cited, as any other optional additives usually used to prepare cellulose derivatives and more particularly cellulose acetate, for example depending on the application.

The composition may also comprise an additional plasticizer or co-plasticizer being different from the plasticizer according to the present invention.

Among said additional plasticizer or co-plasticizer the following may be cited: triacetin, diethyl phthalate, dimethyl phthalate, butyl phthalyl butyl glycolate, diethyl citrate, dimethoxy ethyl phthalate, ethyl phthalyl ethyl glycolate, methyl phthalyl ethyl glycolate, sulfonamides n-ethyl-o, p-toluene, triphenyl phosphate, tricresyl phosphate, dibutoxy ethyl phthalate, diamyl phthalate, tributyl citrate, acetyl tributyl citrate, acetyl tripropyl citrate, tripropionin, tributyrin, o,p-toluene sulfonamide, pentaerythritol tetraacetate, dibutyl tartrate, diethylene glycol diacetate, diethylene glycol dipropionate, dibutyl adipate, dioctyl adipate, dibutyl azelate, trichloroethyl phosphate, tributyl phosphate, di-n-butyl sebacate, dibutyl phthalate, dioctyl phthalate, butylbenzyl phthalate, 2-ethylhexyl adipate, di-2-ethylhexyl phthalate and mixtures thereof.

When present, the additional compounds may be present in the composition in a content ranging from 0.05 to 15% by weight and preferably ranging from 0.1 to 10% by weight relative to the total weight of the composition.

It is a matter of routine operations for a person skilled in the art to adjust the nature and amount of the additional compounds present in the compositions in accordance with the invention such that the desired properties thereof are not thereby affected.

This is all the more true in connection to the optional presence of an additional plasticizer that should not alter the desired properties in connection to the presence of a plasticizer of formula (II), in particular with respect to the plasticizing power and the limited exudation.

In a preferred aspect of the invention, the present invention relates to a plasticized cellulose ester derivative composition comprising

(a) at least one cellulose ester derivative, which is present in an amount ranging from 60 and 95% by weight, in particular from 65 to 85% by weight, more particularly from 70 to 80% by weight, with respect to the total weight of the composition,

(b) at least one compound of formula (III), which is present in an amount ranging from 5 and 40% by weight, in particular from 15 to 35% by weight, more particularly from 20 to 30% by weight, with respect to the total weight of the composition, and

(c) optionally at least one additional compound, which is present in an amount ranging from 0 to 15% by weight, in particular from 0.1 to 10% by weight, with respect to the total weight of the composition.

The composition according to the invention may further encompass at least one additional compound.

Among said additional compounds, anti-UV compounds, stabilizers, acid scavengers, lubricants, pigments, dyes, odor maskers, brighteners and mixtures thereof may be cited, as any other optional additives usually used to prepare cellulose derivatives and more particularly cellulose acetate, for example depending on the application.

The composition may also comprise an additional plasticizer or co-plasticizer being different from the plasticizer according to the present invention.

Among said additional plasticizer or co-plasticizer the following may be cited: triacetin, diethyl phthalate, dimethyl phthalate, butyl phthalyl butyl glycolate, diethyl citrate, dimethoxy ethyl phthalate, ethyl phthalyl ethyl glycolate, methyl phthalyl ethyl glycolate, sulfonamides n-ethyl-o, p-toluene, triphenyl phosphate, tricresyl phosphate, dibutoxy ethyl phthalate, diamyl phthalate, tributyl citrate, acetyl tributyl citrate, acetyl tripropyl citrate, tripropionin, tributyrin, o,p-toluene sulfonamide, pentaerythritol tetraacetate, dibutyl tartrate, diethylene glycol diacetate, diethylene glycol dipropionate, dibutyl adipate, dioctyl adipate, dibutyl azelate, trichloroethyl phosphate, tributyl phosphate, di-n-butyl sebacate, dibutyl phthalate, dioctyl phthalate, butylbenzyl phthalate, 2-ethylhexyl adipate, di-2-ethylhexyl phthalate and mixtures thereof.

When present, the additional compounds may be present in the composition in a content ranging from 0.05 to 15% by weight and preferably ranging from 0.1 to 10% by weight relative to the total weight of the composition.

It is a matter of routine operations for a person skilled in the art to adjust the nature and amount of the additional compounds present in the compositions in accordance with the invention such that the desired properties thereof are not thereby affected.

This is all the more true in connection to the optional presence of an additional plasticizer that should not alter the desired properties in connection to the presence of a plasticizer of formula (III), in particular with respect to the plasticizing power and the limited exudation.

In a further aspect of the invention, the at least one plasticizer is an acyl trialkyl citrate, preferably acetyl triethyl citrate.

Not all the plasticizers and families of plasticizers are sufficiently compatible with cellulose ester derivatives or have sufficient plasticizing power. In particular in order for some plasticizers to achieve sufficient plasticisation and lower the softening temperature of cellulose acetate sufficiently, they must be added in such a high quantity that they impair the mechanical properties of the finished products and make it unusable in some applications.

A sufficient plasticization is achieved when a homogeneous mixture of cellulose ester derivative and plasticizer is obtained after processing. In addition the resulting plasticized composition displays similar mechanical, optical and rheological properties. The mixture can be qualified as homogeneous when no white marks or spots are visible after processing through the extruder. On the contrary, in the case of insufficient plasticization white marks or spots are visible.

In order to obtain sufficient plasticization it is preferable to use a twin screw extruder. The use of a twin screw extruder will favor a sufficient mixture or the cellulose ester derivative with the plasticizer. Therefore a sufficiently plasticized composition according to the present invention can be extruded using a twin-screw extruder.

In addition a sufficient plasticization of the cellulose ester derivative can mean that the plasticized composition can be easily processed. On the other hand in the case of insufficient plasticization, the composition will prove difficult to process or to expel from the extruder. Therefore a sufficiently plasticized composition according to the present invention can be easily processed.

### Process According to the Invention

A composition according to the present invention may be prepared according to the general knowledge of a person skilled in the art.

The plasticizer may be liquid or solid.

The preparation of the composition according to the present invention may merely consist in a direct implementation by a melt way of a mixture of the cellulose derivative with the plasticizer having preferably a molecular weight from 200 to 600, more particularly from 250 to 500, and even more particularly from 350 to 450 g/mol and optionally with at least one additional compound as defined above. It may more precisely consist in blending the melted cellulose derivative, the plasticizer and the at least one additional compound. The melting temperature may be preferably set from 160 to 220° C. Said mixture is generally carried out without solvent.

The process for the manufacture of a plasticized article also forms part of the invention. Therefore the present invention also concerns a process for the manufacture of a plasticized article comprising the steps of:

(a) having a composition according to the present invention, and

(b) forming the composition to produce the article.

The composition according to step (a) may comprise a compound extracted from a vegetable biomass. Therefore, said process may be preceded by a step of extraction of such compound from a vegetable biomass.

Step (b) may be performed according to usual means known from the man skilled in the art, i.e. extrusion and injection molding.

The preparation of the composition according to the present invention may merely consist in a direct implementation by a melt way of a mixture of the cellulose derivative with the plasticizer of formula (I), and optionally with at least one additional compound as defined above. It may more precisely consist in blending the melted cellulose derivative, the plasticizer and the at least one additional compound. The melting temperature may be preferably set from 160 to 220° C. Said mixture is generally carried out without solvent.

The process for the manufacture of a plasticized article also forms part of the invention. Therefore the present invention also concerns a process for the manufacture of a plasticized article comprising the steps of:

(a) having a composition according to the present invention, and

(b) forming the composition to produce the article.

The composition according to step (a) may comprise a compound of formula (I) extracted from a vegetable biomass. Therefore, said process may be preceded by a step of extraction of a compound of formula (I) from a vegetable biomass.

Step (b) may be performed according to usual means known from the man skilled in the art, i.e. extrusion and injection molding.

The preparation of the composition according to the present invention may merely consist in a direct implementation by a melt way of a mixture of the cellulose derivative with the plasticizer of formula (II) and optionally with at least one additional compound as defined above. It may more precisely consist in blending the melted cellulose derivative, the plasticizer and the at least one additional compound. The melting temperature may be preferably set from 160 to 220° C. Said mixture is generally carried out without solvent.

The process for the manufacture of a plasticized article also forms part of the invention. Therefore the present invention also concerns a process for the manufacture of a plasticized article comprising the steps of:

(a) having a composition according to the present invention, and

(b) forming the composition to produce the article.

The composition according to step (a) may comprise a compound of formula (II) extracted from a vegetable biomass. Therefore, said process may be preceded by a step of extraction of a compound of formula (II) from a vegetable biomass.

Step (b) may be performed according to usual means known from the man skilled in the art, i.e. extrusion and injection molding.

The preparation of the composition according to the present invention may merely consist in a direct implementation by a melt way of a mixture of the cellulose derivative with the plasticizer of formula (III) and optionally with at least one additional compound as defined above. It may more precisely consist in blending the melted cellulose derivative, the plasticizer and the at least one additional compound. The melting temperature may be preferably set from 160 to 220° C. Said mixture is generally carried out without solvent.

The process for the manufacture of a plasticized article also forms part of the invention. Therefore the present invention also concerns a process for the manufacture of a plasticized article comprising the steps of:

(a) having a composition according to the present invention, and

(b) forming the composition to produce the article.

The composition according to step (a) may comprise a compound of formula (III) extracted from a vegetable biomass. Therefore, said process may be preceded by a step of extraction of a compound of formula (III) from a vegetable biomass.

Step (b) may be performed according to usual means known from the man skilled in the art, i.e. extrusion and injection molding.

The preparation of the composition according to the present invention may merely consist in a direct implementation by a melt way of a mixture of the cellulose derivative with the plasticizer selected from acyl trialkyl citrate, preferably acetyl triethyl citrate and optionally with at least one additional compound as defined above. It may more precisely consist in blending the melted cellulose derivative, the plasticizer and the at least one additional compound. The melting temperature may be preferably set from 160 to 220° C. Said mixture is generally carried out without solvent.

The process for the manufacture of a plasticized article also forms part of the invention. Therefore the present invention also concerns a process for the manufacture of a plasticized article comprising the steps of:

(a) having a composition according to the present invention, and

(b) forming the composition to produce the article.

Step (b) may be performed according to usual means known from the man skilled in the art, i.e. extrusion and injection molding.

### Applications

Depending on the way it has been processed cellulose derivatives, and more particularly cellulose acetate, can be used for great varieties of applications (e.g. for films, membranes or fibers and also for 3D objects).

In a particular embodiment the composition according to the present invention can be used for human or animal food contact applications or for a packaging of a product destined for human or animal contact applications.

In one aspect of the invention the composition can be used in a plasticized article for cosmetic or personal care packaging, food packaging, personal care supplies, automotive or furniture trims, wiring or electronic devices, toys, home appliances or tool handles.

A plasticized article as a 3D object may be for example a cosmetic packaging, food packaging, hair accessories, wiring devices, electronic devices, home appliances, eye glass frames and tool handles.

The properties of the applied cellulose acetates are very important for these applications. Another special field for using cellulose acetate is the synthesis of porous, spherical particles, so called cellulose beads.

The applicative domain of the invention can be extended to domains for which the occurrence of this type of plasticizer can increase some specific properties such as optical performance retardation films.

The examples below of compositions according to the invention are given as illustrations with no limiting nature.

### Properties

It was found that the plasticized articles according to the present invention display a combination of advantageous properties, including:
avoiding the phenomenon of exudation of the at least one plasticizer;
increasing the maximal use temperature in applications for a material comprising cellulose ester derivative; and
allowing the implementation of cellulose ester derivative, in particular cellulose acetate, in manufacturing processes without altering the rheological and mechanical properties of these materials.

The optical properties of the plasticized composition according to the present invention are comparable to those obtained with reference composition.

The plasticized compositions according to the present invention are compatible for food contact. These compositions are in compliance with the regulation and are therefore compatible applications where the plasticized composition is in contact with food.

Should the disclosure of any patents, patent applications, and publications which are incorporated herein by reference conflict with the description of the present application to the extent that it may render a term unclear, the present description shall take precedence.

### EXAMPLES

Comparative examples are incorporated for comparative purposes with plasticized cellulose acetate composition comprising triacetin and diethylphtalate, considered as reference plasticizers.

Compositions according to the invention are illustrated in example 1 to 9.

Results with respect to the plasticizing power and exudation in connection to compositions according to the invention in comparison to the reference composition are reported.

“DS” means Degree of Substitution.

### Example 1: Preparation of a Plasticized Cellulose Acetate Composition Comprising Dibenzoyl Triethylene Glycol (70/30 (w/w) Composition)

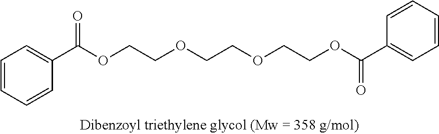 [SMILES: O=C(OCCOCCOCCOC(=O)c1ccccc1)c1ccccc1]

7 grams of Cellulose Acetate (DS=2.45) and 3 grams of DiBenzoyl-TriethyleneGlycol have been mixed at 200° C. through micro-extrusion then micro-injection, said trials being performed on a DSM micro-compounder, in order to obtain injection moulded sheets that can be further characterized. Said sheets present a size of 90×13×2 mm³.

The polymer-plasticizer composition (70/30 w/w) is then characterized by:
Differential Scanning calorimetry (DSC) which permits to identify the decrease of the Glass Transition Temperature (Tg1) of the composition as compared to the Glass Transition Temperature (Tg0) of the polymer as such, and permits to measure the Plasticizing Power (Tg0-Tg1) of the plasticizer used
Isothermal ThermoGravimetric Analysis (I-TGA) performed after heating at 60° C. during 20 hours which permits to measure the amount of plasticizer that can exudate from the polymer matrix over time.

### Example 2: Preparation of a Plasticized Cellulose Acetate Composition Comprising Dibenzoyl Triethylene Glycol (80/20 (w/w) Composition)

Cellulose acetate was firstly impregnated with the molten plasticizer by using a WAM mixer (12 L) under the following conditions:
Mobile speed 150 rpm,
Spraying: flat fan nozzle spraying system, lbar, during 20 minutes
Mixing during 1 hour.

The pre-impregnated powder has then been introduced in the second zone through a side feeder of a twin-screw extruder Leistritz (diameter 18 mm, Length/Diameter=44). The following conditions are used:
Rate: 2 kg/h
Screw speed: 150 rpm
Temperature profile from the feeding zone to the die: from 40° C. to 215° C.

At the exit die, the stand has been granulated. 2 to 4 kg of plasticized composition have been prepared to be then molded in injection. The composition prepared exhibit a full plasticization; no residues of unplasticized powder was visible by eye.

The polymer-plasticizer composition (70/30 w/w) is then characterized by:
Differential Scanning calorimetry (DSC) which permits to identify the decrease of the Glass Transition Temperature (Tg1) of the composition as compared to the Glass Transition Temperature (Tg0) of the polymer as such, and permits to measure the Plasticizing Power (Tg0-Tg1) of the plasticizer used
Isothermal ThermoGravimetric Analysis (I-TGA) performed after heating at 60° C. during 20 hours which permits to measure the amount of plasticizer that can exudate from the polymer matrix over time.

### Example 3: Preparation of a Plasticized Cellulose Acetate Composition Comprising diHydroxyBenzoyl-TriethyleneGlycol (70/30 (w/w) Composition)

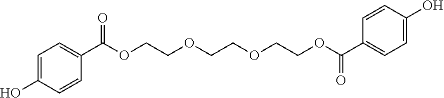 [SMILES: O=C(OCCOCCOCCOC(=O)c1ccc(O)cc1)c1ccc(O)cc1]

7 grams of Cellulose Acetate (DS=2.45) and 3 grams of DihydroxyBenzoyl-TriethyleneGlycol have been mixed at 210° C. through micro-extrusion then micro-injection in order to obtain injection moulded sheets that can be further characterized.

The polymer-plasticizer composition (70/30 w/w) is then characterized by:
Differential Scanning calorimetry (DSC) which permits to identify the decrease of the Glass Transition Temperature (Tg1) of the composition as compared to the Glass Transition Temperature (Tg0) of the polymer as such, and permits to measure the Plasticizing Power (Tg0-Tg1) of the plasticizer used
Isothermal ThermoGravimetric Analysis (I-TGA) performed after heating at 60° C. during 20 hours which permits to measure the amount of plasticizer that can exudate from the polymer matrix over time.

### Example 4: Preparation of a Plasticized Cellulose Acetate Composition Comprising Dicinnamoyl triethyleneGlycol (70/30 (w/w) Composition)

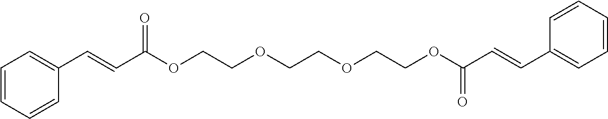 [SMILES: O=C(/C=C/c1ccccc1)OCCOCCOCCOC(=O)/C=C/c1ccccc1]

7 grams of Cellulose Acetate (DS=2.45) and 3 grams of DiCinnamoyl-TriethyleneGlycol have been mixed at 210° C. through micro-extrusion then micro-injection in order to obtain injection moulded sheets that can be further characterized.

The polymer-plasticizer composition (70/30 w/w) is then characterized by:
Differential Scanning calorimetry (DSC) which permits to identify the decrease of the Glass Transition Temperature (Tg1) of the composition as compared to the Glass Transition Temperature (Tg0) of the polymer as such, and permits to measure the Plasticizing Power (Tg0-Tg1) of the plasticizer used
Isothermal ThermoGravimetric Analysis (I-TGA) performed after heating at 60° C. during 20 hours which permits to measure the amount of plasticizer that can exudate from the polymer matrix over time.

### Example 5: Preparation of a Plasticized Cellulose Acetate Composition Comprising Acetyl Triethyl Citrate (70/30 (w:w) Composition)

A twin-screw extruder Clextral, with a diameter 32 mm and a length over diameter ration L/D of 44 has been used. Cellulose acetate powder (DS=2.45, D50 of 180 μm) and diethylphtalate (70/30 (w:w) composition) are introduced in the first two zones of the barrel.

The following conditions are used:
Rate: 10 kg/h
Screw speed: 200 rpm
Temperature profile from the feeding zone to the die: from 20° C. to 210° C.

At the exit die, the stand has been granulated. 30 kg of plasticized composition have been prepared to be then molded in injection. The composition prepared exhibit a full plasticization; no residues of unplasticized powder was visible by eye.

The polymer-plasticizer composition (70/30 w/w) is then characterized by:
Differential Scanning calorimetry (DSC) which permits to identify the decrease of the Glass Transition Temperature (Tg1) of the composition as compared to the Glass Transition Temperature (Tg0) of the polymer as such, and permits to measure the Plasticizing Power (Tg0-Tg1) of the plasticizer used
Isothermal ThermoGravimetric Analysis (I-TGA) performed after heating at 60° C. during 20 hours which permits to measure the amount of plasticizer that can exudate from the polymer matrix over time.

### Example 6: Preparation of a Plasticized Cellulose Acetate Composition Comprising Methyl-Trans-Cinnamate (MTC) (80/20 (w/w) Composition)

8 grams of Cellulose Acetate (DS=2.45) and 2 grams of MTC have been mixed at 185° C. through micro-extrusion then micro-injection in order to obtain injection moulded sheets that can be further characterized. The polymer-plasticizer composition (80/20 w/w) is then characterized by:
Differential Scanning calorimetry (DSC) which permits to identify the decrease of the Glass Transition Temperature (Tg1) of the composition as compared to the Glass Transition Temperature (Tg0) of the polymer as such, and permits to measure the Plasticizing Power (Tg0-Tg1) of the plasticizer used
Isothermal ThermoGravimetric Analysis (I-TGA) performed after heating at 60° C. during 20 hours which permits to measure the amount of plasticizer that can exudate from the polymer matrix over time.

### Example 7: Preparation of a Plasticized Cellulose Acetate Composition Comprising Methyl-Trans-Cinnamate (MTC) (70/30 (w/w) Composition)

7 grams of Cellulose Acetate (DS=2.45) and 3 grams of MTC have been mixed at 175° C. through micro-extrusion then micro-injection in order to obtain injection moulded sheets that can be further characterized. The polymer-plasticizer composition (70/30 w/w) is then characterized by:
Differential Scanning calorimetry (DSC) which permits to identify the decrease of the Glass Transition Temperature (Tg1) of the composition as compared to the Glass Transition Temperature (Tg0) of the polymer as such, and permits to measure the Plasticizing Power (Tg0-Tg1) of the plasticizer used
Isothermal ThermoGravimetric Analysis (I-TGA) performed after heating at 60° C. during 20 hours which permits to measure the amount of plasticizer that can exudate from the polymer matrix over time.

### Example 8: Preparation of a Plasticized Cellulose Acetate Composition Comprising Methyl-4-HydroxyCinnamate (M4HC) (80/20 (w/w) Composition)

8 grams of Cellulose Acetate (DS=2.45) and 2 grams of M4HC have been mixed at 185° C. through micro-extrusion then micro-injection in order to obtain injection moulded sheets that can be further characterized. The polymer-plasticizer composition (80/20 w/w) is then characterized by:
Differential Scanning calorimetry (DSC) which permits to identify the decrease of the Glass Transition Temperature (Tg1) of the composition as compared to the Glass Transition Temperature (Tg0) of the polymer as such, and permits to measure the Plasticizing Power (Tg0-Tg1) of the plasticizer used
Isothermal ThermoGravimetric Analysis (I-TGA) performed after heating at 60° C. during 20 hours which permits to measure the amount of plasticizer that can exudate from the polymer matrix over time.

### Example 9: Preparation of a Plasticized Cellulose Acetate Composition Comprising Methyl-4-HydroxyCinnamate (M4HC) (70/30 (w/w) Composition)

7 grams of Cellulose Acetate (DS=2.45) and 3 grams of M4HC have been mixed at 175° C. through micro-extrusion then micro-injection in order to obtain injection moulded sheets that can be further characterized. The polymer-plasticizer composition (70/30 w/w) is then characterized by:
Differential Scanning calorimetry (DSC) which permits to identify the decrease of the Glass Transition Temperature (Tg1) of the composition as compared to the Glass Transition Temperature (Tg0) of the polymer as such, and permits to measure the Plasticizing Power (Tg0-Tg1) of the plasticizer used
Isothermal ThermoGravimetric Analysis (I-TGA) performed after heating at 60° C. during 20 hours which permits to measure the amount of plasticizer that can exudate from the polymer matrix over time.

### Comparative Example 1: Preparation of a Plasticized Cellulose Acetate Composition Comprising Triacetin (70/30 (w:w) Composition)

7 grams of Cellulose Acetate (DS=2.45) and 3 grams of triacetin have been mixed at 190° C. through micro-extrusion then micro-injection in order to obtain injection moulded sheets that can be further characterized. The polymer-plasticizer composition (70/30 w/w) is then characterized by:
Differential Scanning calorimetry (DSC) which permits to identify the decrease of the Glass Transition Temperature (Tg1) of the composition as compared to the Glass Transition Temperature (Tg0) of the polymer as such, and permits to measure the Plasticizing Power (Tg0-Tg1) of the plasticizer used
Isothermal ThermoGravimetric Analysis (I-TGA) performed after heating at 60° C. during 20 hours which permits to measure the amount of plasticizer that can exudate from the polymer matrix over time.

### Comparative Example 2: Preparation of a Plasticized Cellulose Acetate Composition Comprising Triacetin (80/20 (w:w) Composition)

8 grams of Cellulose Acetate (DS=2.45) and 2 grams of triacetin have been mixed at 200° C. through micro-extrusion then micro-injection, said trials being performed on a DSM micro-compounder, in order to obtain injection moulded sheets that can be further characterized.

Said sheets present a size of 90×13×2 mm³. The polymer-plasticizer composition (80/20 w/w) is then characterized by:
Differential Scanning calorimetry (DSC) which permits to identify the decrease of the Glass Transition Temperature (Tg1) of the composition as compared to the Glass Transition Temperature (Tg0) of the polymer as such, and permits to measure the Plasticizing Power (Tg0-Tg1) of the plasticizer used
Isothermal ThermoGravimetric Analysis (I-TGA) (performed on a TG209 F1 Thermogravimetric Analyser commercialized by the NETZSCH Company) performed after heating at 60° C. during 20 hours which permits to measure the amount of plasticizer that can exudate from the polymer matrix over time.

### Comparative Example 3: Preparation of a Plasticized Cellulose Acetate Composition Comprising Diethylphtalate (70/30 (w:w) Composition)

A twin-screw extruder Clextral, with a diameter 32 mm and a length over diameter ration L/D of 44 has been used. Cellulose acetate powder (DS=2.45, D50 of 180 μm) and diethylphtalate (70/30 (w:w) composition) are introduced in the first two zones of the barrel.

The following conditions are used:
Rate: 10 kg/h
Screw speed: 200 rpm
Temperature profile from the feeding zone to the die: from 20° C. to 210° C.

At the exit of the die, the stand has been granulated. 30 kg of plasticized composition have been prepared to be then molded in injection. The composition prepared exhibit a full plasticization; no residues of unplasticized powder was visible by eye.

The plasticized composition is then characterized by:
Differential Scanning calorimetry (DSC) which permits to identify the decrease of the Glass Transition Temperature (Tg1) of the composition as compared to the Glass Transition Temperature (Tg0) of the polymer as such, and permits to measure the Plasticizing Power (Tg0-Tg1) of the plasticizer used
Isothermal ThermoGravimetric Analysis (I-TGA) performed after heating at 60° C. during 20 hours which permits to measure the amount of plasticizer that can exudate from the polymer matrix over time.

The results from Example 1 to 9 and the Comparative Examples are listed in the following Table:

| | | Plasticizing | Exudation |
|---|---|---|---|
| | Tg1 | Power | Amount |
| Plasticizer | (° C.) | (° C.) (*) | (% w) |
| Example 1: Triethylene glycol | 125 | 68 | 0.60 |
| dibenzoate (70/30 (w/w) Composition) | | | |
| Example 2: Triethylene glycol | 118 | 75 | Not |
| dibenzoate (80/20 (w/w) Composition) | | | measured |
| Example 3: DiHydroxyBenzoyl- | 115 | 78 | 0.10 |
| TriethyleneGlycol | | | |
| (70/30 (w/w) Composition) | | | |
| Example 4: Dicinnamoyl | 135 | 58 | 0.50 |
| triethyleneGlycol (70/30 (w/w) | | | |
| Composition) | | | |
| Example 5: Acetyl triethyl citrate | 114 | 79 | 0.60 |
| (70/30 (w:w) Composition) | | | |
| Example 6: Methyl-trans-Cinnamate | 109 | 84 | 2.35 |
| (MTC) (80/20 (w/w) Composition) | | | |
| Example 7: Methyl-trans-Cinnamate | 90 | 103 | 2.30 |
| (MTC) (70/30 (w/w) Composition) | | | |
| Example 8: Methyl-4-Hydroxy- | 107 | 86 | 0.75 |
| Cinnamate (M4HC) (80/20 (w/w) | | | |
| Composition) | | | |
| Example 9: Methyl-4-Hydroxy- | 85 | 108 | 0.80 |
| Cinnamate (M4HC) (70/30 (w/w) | | | |
| Composition) | | | |
| Comparative example 1: Triacetin | 78 | 115 | 4.00 |
| (70/30 (w:w) Composition) | | | |
| Comparative example 2: Triacetin | 109 | 84 | 2.60 |
| (80/20 (w:w) Composition) | | | |
| Comparative example 3: Diethylphtalate | 100 | 93 | 3.20 |
| (70/30 (w:w) Composition) | | | |

(*) Plasticizing Power = Tg0 − Tg1, with Tg0 = 193° C. (Glass Transition Temperature of Cellulose Acetate DS = 2.45 as such)

The plasticizing power values of the compositions according to the present invention are comparable than the plasticizing power of the reference compositions.

The exudation amounts are under the ones as obtained with the reference compositions.

1. A plasticized cellulose ester derivative composition comprising a cellulose ester derivative and at least one plasticizer having a molecular weight preferably equal to or more than 100 g/mol and equal to or less than 600 g/mol wherein the exudation, determined by Isothermal ThermoGravimetric Analysis after heating at 60° C. during 20 hours, is equal to or less than 2.50%.

2. A plasticized cellulose ester derivative composition according to claim 1 wherein the at least one plasticizer has a molecular weight equal to or more than 200 g/mol, preferably equal to or more than 250 g/mol, preferably equal to or more than 300 g/mol, and equal to or less than 500 g/mol, preferably equal to or less than 450 g/mol.

3. A plasticized cellulose ester derivative composition according to claim 1 wherein the exudation, determined by Isothermal ThermoGravimetric Analysis after heating at 60° C. during 20 hours, is equal to or less than 1.00%, preferably equal to or less than 0.80%, preferably equal to or less than 0.60%), more preferably equal to or less than 0.50%;

4. A plasticized cellulose ester derivative composition according to claim 1 wherein the at least one plasticizer is a polyalkylene glycol ester of formula (I) 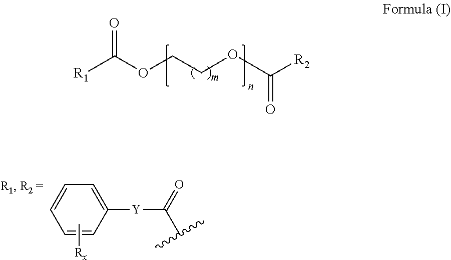
wherein
n is an integer equal to or more than 1 and equal to or less than 5,
m is an integer equal to 1 or 2,
Y represents a bond or a —C═C— in configuration trans or configuration (E),
x is an integer equal to or more than 0 and equal to or less than 5 and
R represents an hydroxyl, a (C₁-C₄) alkyl group or a -0(C₁-C₄) alkyl group.

5. A plasticized cellulose ester derivative composition according to claim 1 wherein the at least one plasticizer is selected from triethylene glycol dibenzoate, diethylene glycol dibenzoate, tripropylene glycol dibenzoate and dipropylene glycol dibenzoate, preferably triethylene glycol dibenzoate.

6. A plasticized cellulose ester derivative composition according to claim 1 comprising a cellulose ester derivative and at least a compound of formula (III) 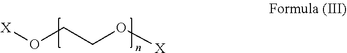
wherein
n represents an integer varying from 1 to 10, and 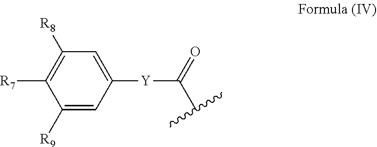
X represents a group of formula (IV) Formula (IV)
with
R₇ represents a hydrogen atom or a hydroxyl group,
R₈ and R₉ independently represent a hydrogen atom, an hydroxyl group, a (C₁-C₄) alkyl group or a -0(C₁-C₄) alkyl group,
Y represents a bond or a group —C═C— in configuration (E),
and when Y is a bond, at least one of R₇, R₈ and R₉ is different from a hydrogen atom.

7. A plasticized cellulose ester derivative composition according to claim 6, wherein compound of formula (III) has a R₇ group being a hydroxyl group or a hydrogen atom, has R₈ and R₉ independently representing a hydrogen atom, a methyl group or a methoxy group, has n being an integer from 2 to 6, preferentially from 2 to 4 and has Y where Y represents a bond or a —C═C— in configuration trans or configuration (E).

8. A plasticized cellulose ester derivative composition according to claim 6 wherein the compound of formula (III) has X representing the group (IVa) 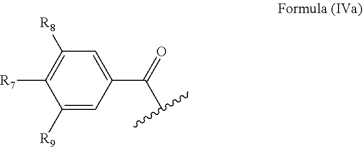
with R₇, R₈, R₉ and n having the same meanings as in claim 6 or 7.

9. plasticized cellulose ester derivative composition according to claim 6 wherein R7 represents a hydroxyl group; R₈ and R9 independently represent a hydrogen atom, a methyl group or a methoxy group and n is an integer from 2 to 6, preferentially from 2 to 4.

10. A plasticized cellulose ester derivative composition according to claim 6 wherein the compound of formula (III) is

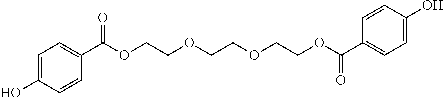 [SMILES: O=C(OCCOCCOCCOC(=O)c1ccc(O)cc1)c1ccc(O)cc1]

11. A plasticized cellulose ester derivative composition according to claim 6, wherein the compound of formula (III) has X representing the group (IVb) 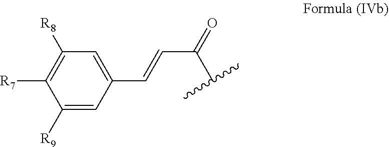
with R₇, R₈, R₉ and n having the same meanings as in claim 6 or 7.

12. A plasticized cellulose ester derivative composition according to claim 11 wherein R₇ is a hydrogen atom; R₈ and R₉ independently represents a hydrogen atom, a methyl group or a methoxy group, and n is an integer from 2 to 6, preferentially from 2 to 4.

13. A plasticized cellulose ester derivative composition according to claim 6, wherein the compound of formula (III) is:

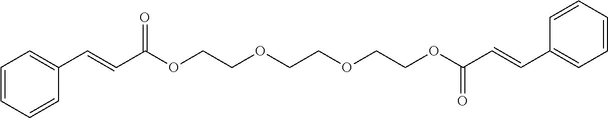 [SMILES: O=C(/C=C/c1ccccc1)OCCOCCOCCOC(=O)/C=C/c1ccccc1]

14. A plasticized cellulose ester derivative composition according to claim 1 wherein the compound of formula (III) is a biobased molecule.

15. A plasticized cellulose ester derivative composition according to claim 1 wherein the at least one plasticizer is an acyl trialkyl citrate, preferably is acetyl triethyl citrate.

16. A plasticized cellulose ester derivative composition comprising a cellulose ester derivative and at least one compound of formula (II) 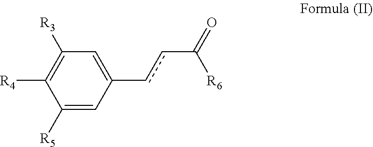
wherein
R₄ represents a hydrogen atom or a hydroxyl group,
R₃ and R₅ independently represent a hydrogen atom, a (C1-C4)alkyl group or a -0(C1-C4)alkyl group,
R-₆ represents a hydrogen atom, an hydroxyl group, a (C1-C4)alkyl group, a benzyl group, a 0(C1 C4)alkyl group or a —Obenzyl group, and [symbol]
represents a single bond or a double bond.

17. The composition according to claim 16, wherein
R₄ represents a hydrogen atom or a hydroxyl group,
R₃ and R₅ independently represent a hydrogen atom or a 0(C1-C4)alkyl group, preferentially a methoxy or ethoxy group, and
R₆ represents a hydrogen atom or a hydroxyl group.

18. The composition according to claim 16 wherein
R₃, R₄, R₅ and R₆ are as defined in claim 16, and [symbol]
represents a single bond.

19. The composition according to claim 16, wherein
R₃, R₄, R₅ and R₆ are as defined in claim 16, and [symbol]
represents a double bond, and more particularly in configuration (E).

20. The composition according to claim 16 wherein the compound of formula (II) is a biobased molecule.

21. The composition according to claim 1 wherein compound (II) is chosen among

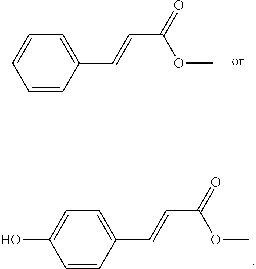

22. A plasticized cellulose ester derivative composition comprising
(a) at least one cellulose ester derivative, which is present in an amount ranging from 60 and 95% by weight, in particular from 65 to 85% by weight, more particularly from 70 to 80% by weight, with respect to the total weight of the composition,
(b) at least one plasticizer as defined in any one of the claims 1 to 21, which is present in an amount ranging from 5 and 40% by weight, in particular from 15 to 35% by weight, more particularly from 20 to 30%) by weight, with respect to the total weight of the composition, and
(c) optionally at least one additional compound, which is present in an amount ranging from 0 to 15% by weight, in particular from 0.1 to 10% by weight, with respect to the total weight of the composition.

23. A plasticized cellulose ester derivative composition comprising
(a) at least one cellulose ester derivative, which is present in an amount ranging from 60 and 95% by weight, in particular from 65 to 85% by weight, more particularly from 70 to 80% by weight, with respect to the total weight of the composition,
(b) at least one compound of formula (I), which is present in an amount ranging from 5 and 40% by weight, in particular from 15 to 35% by weight, more particularly from 20 to 30% by weight, with respect to the total weight of the composition, and
(c) optionally at least one additional compound, which is present in an amount ranging from 0 to 15% by weight, in particular from 0.1 to 10% by weight, with respect to the total weight of the composition.

24. A plasticized cellulose ester derivative composition comprising
(a) at least one cellulose ester derivative, which is present in an amount ranging from 60 and 95% by weight, in particular from 65 to 85% by weight, more particularly from 70 to 80% by weight, with respect to the total weight of the composition, (b) at least one compound of formula (II), which is present in an amount ranging from 5 and 40% by weight, in particular from 15 to 35% by weight, more particularly from 20 to 30% by weight, with respect to the total weight of the composition, and
(c) optionally at least one additional compound, which is present in an amount ranging from 0 to 15% by weight, in particular from 0.1 to 10% by weight, with respect to the total weight of the composition.

25. A plasticized cellulose ester derivative composition comprising
(a) at least one cellulose ester derivative, which is present in an amount ranging from 60 and 95% by weight, in particular from 65 to 85% by weight, more particularly from 70 to 80% by weight, with respect to the total weight of the composition,
(b) at least one compound of formula (III), which is present in an amount ranging from 5 and 40% by weight, in particular from 15 to 35% by weight, more particularly from 20 to 30% by weight, with respect to the total weight of the composition, and
(c) optionally at least one additional compound, which is present in an amount ranging from 0 to 15% by weight, in particular from 0.1 to 10% by weight, with respect to the total weight of the composition.

26. A composition according to claim 1 wherein the additional compound is selected from anti-UV compounds, stabilizers, acid scavengers, lubricants, pigments, dyes, odor maskers, brighteners, additional plasticizer or co-plasticizer and mixtures thereof.

27. A composition according to claim 1 wherein the cellulose ester derivative is selected from cellulose acetate, cellulose propionate, cellulose butyrate, cellulose acetate propionate, cellulose acetate butyrate, cellulose acetate propionate butyrate, carboxymethyl cellulose acetate propionate and mixtures thereof and more particularly is cellulose acetate.

28. A plasticized cellulose ester derivative composition according to claim 1 wherein the degree of substitution of the cellulose ester derivative is equal to or more than 2.0, preferably equal to or more than 2.3, and equal to or less than 3, preferably equal to or less than 2.6, and most preferably the degree of substitution is 2.45.

29. A Use of a compound of formula (I) as defined in claim 4 as plasticizer of a cellulose ester derivative, and more particularly of cellulose ester.

30. A Use of a compound of formula (III) as defined in claim 6 as plasticizer of a cellulose ester derivative, and more particularly of cellulose ester.

31. A Use of a compound of formula (II) as defined in claim 16 as plasticizer of a cellulose ester derivative, and more particularly of cellulose ester.

32. A process for the manufacture of a plasticized article comprising the steps of:
(a) having the composition according to claim 1 and
(b) forming the composition to produce the article, for example by means of extrusion, and injection molding, optionally preceded by a step of extraction of a compound of formula (I) or formula (II) or formula (III) from a vegetable biomass.

33. A process for the manufacture of a plasticized article comprising the steps of:
(a) having the composition according to claim 4, and
(b) forming the composition to produce the article, for example by means of extrusion, and injection molding, optionally preceded by a step of extraction of a compound of formula (I) from a vegetable biomass.

34. A process for the manufacture of a plasticized article comprising the steps of:
(a) having the composition according to claim 6 and
(b) forming the composition to produce the article, for example by means of extrusion, and injection molding, optionally preceded by a step of extraction of a compound of formula (II) from a vegetable biomass.

35. A process for the manufacture of a plasticized article comprising the steps of:
(a) having the composition according to claim 6, and
(b) forming the composition to produce the article, for example by means of extrusion, and injection molding, optionally preceded by a step of extraction of a compound of formula (III) from a vegetable biomass.

36. A method of using of a plasticized cellulose ester derivative composition as said composition comprising a cellulose ester derivative and at least one plasticizer having a molecular weight preferably equal to or more than 100 g/mol and equal to or less than 600 g/mol wherein the exudation, determined by Isothermal ThermoGravimetric Analysis after heating at 60° C. during 20 hours, is equal to or less than 2.50%; said method of use comprising the steps of:
using said plasticized cellulose ester derivative composition in a plasticized article destined for human or animal food contact applications or for a packaging of a product destined for human or animal contact applications.

37. A method of using of a plasticized cellulose ester derivative composition as said composition comprising a cellulose ester derivative and at least one plasticizer having a molecular weight preferably equal to or more than 100 g/mol and equal to or less than 600 g/mol wherein the exudation, determined by Isothermal ThermoGravimetric Analysis after heating at 60° C. during 20 hours, is equal to or less than 2.50%; said method of use comprising the steps of:
using said plasticized cellulose ester derivative composition in a plasticized article for cosmetic or personal care packaging, food packaging, personal care supplies, automotive or furniture trims, wiring or electronic devices, toys, home appliances or tool handles.

38. A method of using of a plasticized cellulose ester derivative composition as said composition comprising a cellulose ester derivative and at least one plasticizer having a molecular weight preferably equal to or more than 100 g/mol and equal to or less than 600 g/mol wherein the exudation, determined by Isothermal ThermoGravimetric Analysis after heating at 60° C. during 20 hours, is equal to or less than 2.50%; said method of use comprising the steps of:
using said plasticized cellulose ester derivative composition for producing a plasticized article selected from a cosmetic packaging, food packaging, hair accessories, wiring devices, electronic devices, home appliances eye glass frame and tool handle.
